(19) United States
(12) Patent Application Publication
(10) Pub. No.: US 2011/0216838 A1
(43) Pub. Date: Sep. 8, 2011

(54) Method and apparatus for efficient decoding of multi-view coded video data

(76) Inventors: Wanrong Lin, Belle Meade, NJ (US); Richard Edward Goedeken, Cranbury, NJ (US); Jiancong Luo, West Windsor, NJ (US)

(21) Appl. No.: 12/932,179

(22) Filed: Feb. 18, 2011

Related U.S. Application Data
(60) Provisional application No. 61/307,051, filed on Feb. 23, 2010.

(51) Int. Cl. H04N 7/26

(52) U.S. Cl. 375/240.25; 375/E07.027

(57) ABSTRACT

A method and apparatus are provided for efficient decoding of multi-view coded video data. The apparatus includes one or more decoders (300) for decoding image data from a bitstream. The image data corresponds to a plurality of pictures for at least two views of multi-view video content. The image data is decoded in parallel in a plurality of at least one of threads and processes. The image data is decoded using a staggered approach such that a decoding of a particular one of the plurality of pictures in a particular one or more of the plurality of at least one of threads and process commences only when inter-view reference pictures corresponding to the particular one of the plurality of pictures are decoded using one or more other ones of the plurality of at least one of threads and processes.

### CROSS-REFERENCE TO RELATED APPLICATIONS

This application claims the benefit of U.S. Provisional Application Ser. No. 61/307,051, filed Feb. 23, 2010, which is incorporated by reference herein in its entirety.

### TECHNICAL FIELD

The present principles relate generally to video decoding and, more particularly, to a method and apparatus for efficient decoding of multi-view coded video data.

### BACKGROUND

Encoded video data is generally described and represented sequentially. For example, in the most successful video coding standards such as the International Organization for Standardization/International Electrotechnical Commission (ISO/IEC) Moving Picture Experts Group-2 (MPEG-2) Standard and the ISO/IEC Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”), including the multi-view video coding (MVC) extension of the MPEG-4 AVC Standard, video data formats are specified as a sequence of syntax elements and, hence, video data is commonly referred to as a video stream or a video bitstream. Therefore, a straightforward implementation of a video stream decoder is generally sequential to make it easy to follow the video coding specification and verify the conformance, just as the reference decoder implementations provided in the aforementioned video standards and recommendations. Also, although it is possible to have parallel decoding at the slice level in some video streams, the temporal dependency among encoded pictures makes picture-level sequential decoding a natural choice, as generally a picture cannot be decoded unless the preceding pictures (in encoding/decoding order) are decoded.

Compressed/encoded digital video data in various formats are widely, if not ubiquitously used in media distribution, processing and storage. Common examples are over-the-air Advanced Television Systems Committee/digital television (ATSC/DTV) broadcasting, digital satellite and cable channels, Internet video streaming, BLU-RAY discs, digital movie shooting and/or processing, and so forth. Being able to decode such video data efficiently is very desirable in that it enables new applications, improves the human experience, and saves cost and/or time, as faster decoding methods/architectures make a video system more responsive, reduce or eliminate video jitter, require less expensive hardware, save computation power to make other processing feasible, reduce processing time, and so forth. Particularly, in many cases, real-time decoding speed is critical to the application.

Two factors pose major challenges to improving video data decoding. First, as the video resolution and frame rate increases, the amount of data to process increases. Secondly, as the encoding algorithms are more and more sophisticated to achieve a better compression ratio, the complexity of decoding the data increases. That is well exemplified in multi-view coded video data.

Multi-view video coding (MVC) is the compression framework for the encoding of multi-view sequences. A multi-view video coding sequence is a set of two or more video sequences that capture the same scene from a different view point.

Multi-view coded video data carries information of multiple pictures for every video frame, each of which represents a “view” from a different perspective at the scene. If only two views are included, an MVC video data stream is normally called a stereoscopic, or 3D video stream, which represents the pictures as normally see in a 3D movie.

In contrast to single view video data streams, multi-view coded video data streams multiply the amount of source raw video data they represent. Further, in addition to intra-view prediction, inter-view prediction may be used to exploit the redundancy between views.

Turning to FIG. 1, an example of intra-view prediction in multi-view video coding is indicated generally by the reference numeral 100. The intra-view prediction 100 involves four views, namely views V0, V1, V2, and V3, at four different time instances, namely, t0, t1, t2, and t3. The letter “I” is used to denote intra coded pictures, and the letter “P” is used to denote inter coded pictures.

Turning to FIG. 2, an example of intra-view prediction and inter-view prediction in multi-view video coding is indicated generally by the reference numeral 200. The intra-view prediction and inter-view prediction 200 involve four views, namely views V0, V1, V2, and V3, at four different time instances, namely t0, t1, t2, and t3. The letter “I” is used to denote intra coded pictures, and the letter “P” is used to denote inter coded pictures.

With inter-view prediction, only one view (V0 in FIG. 2), known as the base view, can be decoded independently without decoding other views. Other views, known as dependent views, depend on (by reference/prediction) one or more other views and cannot be decoded independently.

An MVC decoder in general needs to assume inter-view prediction may be present in an MVC video data stream, as inter-view prediction contributes significantly to coding efficiency. Hence, an MVC decoder faces the increase of both data rate and complexity, which makes it ever more important to have methods and architecture for efficient decoding.

A widely known example of MVC encoding scheme is the MVC extension of the International Organization for Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”).

We note that multi-CPU and/or multi-core general-purpose computers are increasingly common and inexpensive. However, since sequential decoding cannot take advantage of the preceding, the multiplied computation power is wasted.

### SUMMARY

These and other drawbacks and disadvantages of the prior art are addressed by the present principles, which are directed to a method and apparatus for efficient decoding of multi-view coded video data.

According to an aspect of the present principles, there is provided an apparatus. The apparatus includes one or more decoders for decoding image data from a bitstream. The image data corresponds to a plurality of pictures for at least two views of multi-view video content. The image data is decoded in parallel in a plurality of at least one of threads and processes. The image data is decoded using a staggered approach such that a decoding of a particular one of the plurality of pictures in a particular one or more of the plurality of at least one of threads and process commences only when inter-view reference pictures corresponding to the particular one of the plurality of pictures are decoded using one or more other ones of the plurality of at least one of threads and processes.

According to another aspect of the present principles, there is provided a method performed by one or more decoders. The method includes decoding image data from a bitstream, the image data corresponding to a plurality of pictures for at least two views of multi-view video content, wherein the image data is decoded in parallel in a plurality of at least one of threads and processes, the image data being decoded using a staggered approach such that a decoding of a particular one of the plurality of pictures in a particular one or more of the plurality of at least one of threads and process commences only when inter-view reference pictures corresponding to the particular one of the plurality of pictures are decoded using one or more other ones of the plurality of at least one of threads and processes.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing an example of intra-view prediction in multi-view video coding to which the present principles may be applied;

FIG. 2 is a diagram showing an example of intra-view prediction and inter-view prediction in multi-view video coding to which the present principles may be applied;

FIG. 3 is a block diagram showing an exemplary multi-view video decoder, in accordance with an embodiment of the present principles;

FIG. 4 is a diagram showing the general structure of a multi-view video coding bitstream to which the present principles may be applied, in accordance with an embodiment of the present principles;

FIG. 5 is a diagram showing an exemplary staggered multi-view video decoding scheme, in accordance with an embodiment of the present principles;

FIG. 6 is a diagram showing another exemplary staggered multi-view video decoding scheme, in accordance with an embodiment of the present principles;

FIG. 7 is a diagram showing an exemplary structure of the threads for decoding bitstreams encoded using the MVC extension of the MPEG-4 AVC Standard, in accordance with an embodiment of the present principles; and

FIG. 8 is a flow diagram showing an exemplary method for decoding multi-view coded video data, in accordance with an embodiment of the present principles.

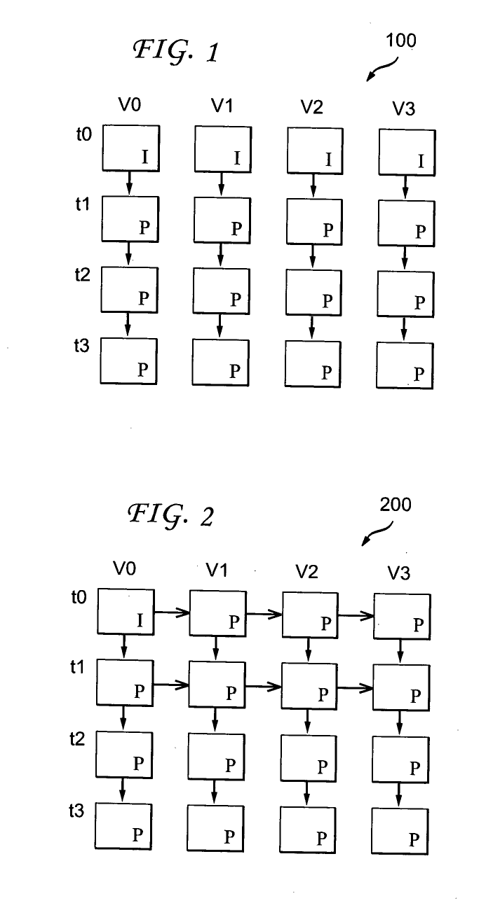

### DETAILED DESCRIPTION

The present principles are directed to a method and apparatus for efficient decoding of multi-view coded video data.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

Also, as used herein, the word “dependency” refers to the condition where the decoding of a particular picture (e.g., a picture in the aforementioned set) is dependent on the prior decoding of one or more other pictures. For example, the other picture may be a reference picture for the particular picture and, in the case of multi-view coded video content, may pertain to either the same view or a different view. In the latter case, such a reference picture can be referred to as a cross-view or inter-view reference picture.

Additionally, as interchangeably used herein, “cross-view” and “inter-view” both refer to pictures that belong to a view other than a current view. Moreover, as used herein, the word “thread” refers to a sequence of instructions which may, in accordance with the present principles, be executed in parallel with other threads (i.e., other sequences of instructions).

Further, as used herein, the word “process” refers to a computer program or instance of a computer program which may, in accordance with the present principles, run concurrently with other computer programs.

Also, as interchangeably used herein, “processor” and “core” both refer to an electronic circuit or portion thereof capable of executing instructions and computer programs. It is to be appreciated that one or more “cores” may be part of a “processor” in some implementations. Additionally, it is to be appreciated that one or more processors may be part of a multi-processor integrated circuit chip in other implementations. These and other variations of processors and cores are readily determined by one of ordinary skill in this and related arts.

Moreover, it is to be appreciated that while one or more embodiments of the present principles are described herein with respect to the multi-view video coding extension of the MPEG-4 AVC Standard, the present principles are not limited to solely this extension and/or this standard and, thus, may be utilized with respect to other video coding standards, recommendations, and extensions thereof, while maintaining the spirit of the present principles. Further, it is to be appreciated that while the following description may thus refer to terms specific to the multi-view video coding extension of the MPEG-4 AVC Standard, such reference to such terms should also be considered for their corresponding generic multi-view video coding concepts when appropriate, as readily ascertained by one of ordinary skill in this and related arts.

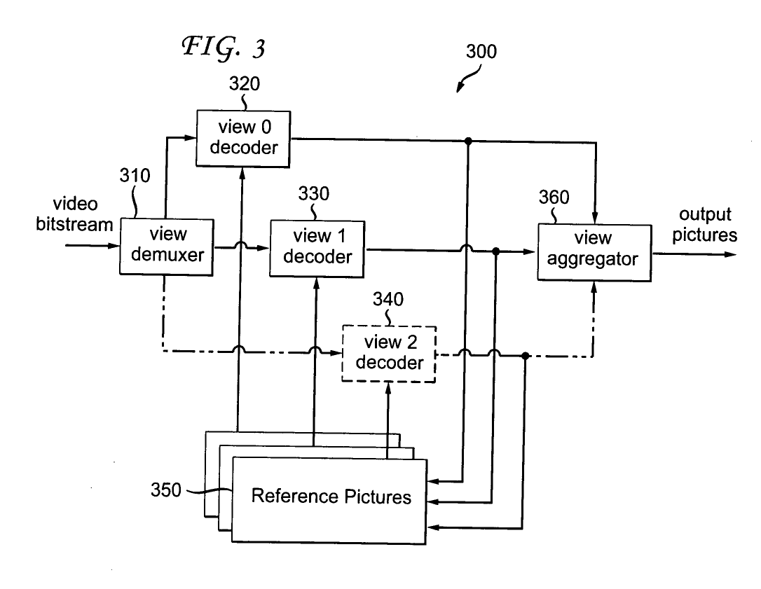

Turning to FIG. 3, an exemplary multi-view video decoder is indicated generally by the reference numeral 300. The video decoder 300 includes a view de-multiplexer (demuxer) 310 having a first output in signal communication with a first input of a view 0 decoder 320, a second output in signal communication with a first input of a view 1 decoder 330, and a third output in signal communication with a first input of a view 2 decoder 340. An output of the view 0 decoder 320 is connected in signal communication with a first input of a view aggregator 360 and a first input of a reference pictures store 350. An output of the view 1 decoder 330 is connected in signal communication with a second input of the view aggregator 260 and a second input of the reference pictures store 350. An output of the view 2 decoder 340 is connected in signal communication with a third input of the view aggregator 360 and a third input of a reference pictures store 350. A first output of the reference pictures store 350 is connected in signal communication with a second input of the view 0 decoder 320. A second output of the reference pictures store 350 is connected in signal communication with a second input of the view 1 decoder 330. A third output of the reference pictures store 350 is connected in signal communication with a second input of the view 2 decoder 340. An output of the view de-multiplexer 310 is available as an input to the video decoder 300, for receiving an input bitstream. An output of the view aggregator 360 is available as an output of the video decoder 300, for providing output pictures.

As noted above, despite the fact that multi-CPU and/or multi-core general-purpose computers are increasingly common and inexpensive, sequential decoding cannot take advantage of the same, leaving the multiplied computation power wasted. Advantageously, the present principles address this issue by exploiting the parallelization opportunities in the MVC encoding scheme.

In accordance with the present principles, a method and apparatus are provided for efficient decoding of multi-view coded (MVC) video data. The architecture provided by the present principles improves decoding efficiency by parallelizing data processing and exploiting the computation power from multiple hardware processing units (either general purpose CPU/cores or specialized hardware).

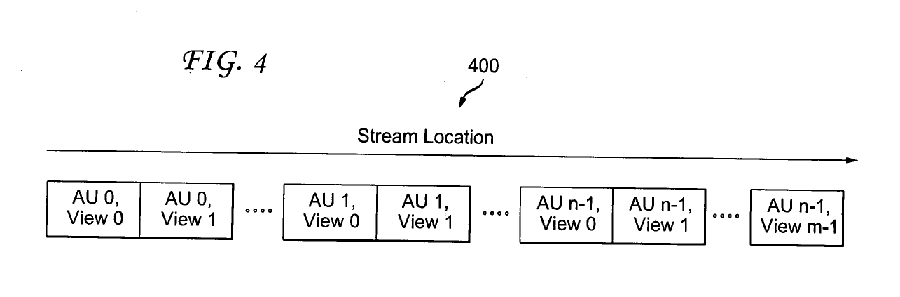

Turning to FIG. 4, the general structure of a multi-view video coding bitstream is indicated generally by the reference numeral 400. In FIG. 4, an access unit (also interchangeably referred to herein as “AU”) is the group of pictures of all views for a scene captured at a particular time. Within an access unit, the order of view pictures is such so that any view can only use inter-view prediction on the preceding view pictures.

A key fact in the MVC encoding scheme is that when inter-view prediction is concerned, the referencing pictures and the referenced pictures are always in the same access unit or within a bounded relative range of access units. This provides an opportunity for parallelizing the decoding of different views.

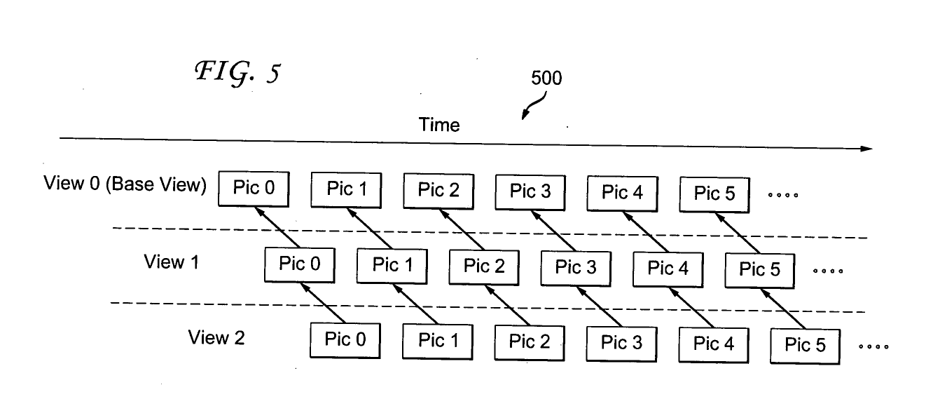

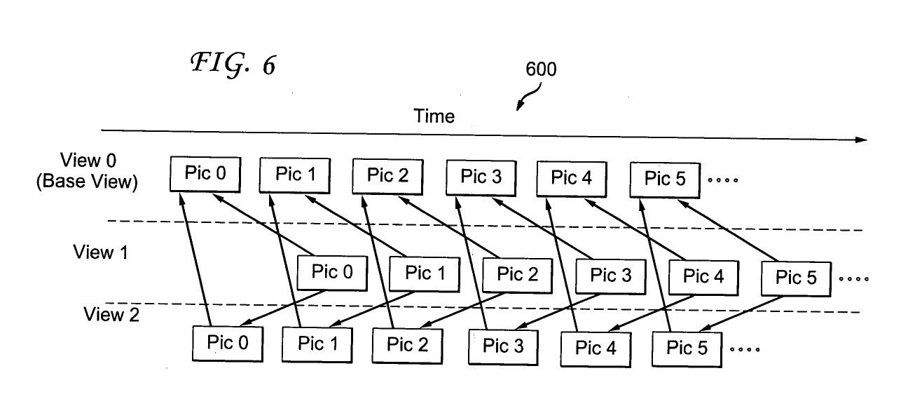

Turning to FIG. 5, an exemplary staggered multi-view video decoding scheme is indicated generally by the reference numeral 500. The staggered MVC scheme 500 involves a base view (View 0) and two dependent views (View 1 and View 2).

By introducing a time lag between the decoding of different views, all the views in a video bitstream can be decoded simultaneously. The arrows in FIG. 5 show the dependency between view pictures captured at the same time. The arrows between pictures in the same view are omitted since the temporal dependency within the same view does not affect the decoding timing illustrated in the Figures.

At the time to decode picture 0 in View 1, picture 0 in View 0 is already decoded and ready for reference. The same applies to picture 0 in View 2, or any other pictures. If a thread/process is created to decode each view, multiple processors or other processing units can be utilized in this staggered scheme to significantly speed up (most likely by multiple times) the decoding compared with sequential decoding.

Turning to FIG. 6, another exemplary staggered multi-view video decoding scheme is indicated generally by the reference numeral 600. The staggered MVC scheme 600 involves a base view (View 0) and two dependent views (View 1 and View 2). In the example of FIG. 6, both View 1 and View 2 depend directly on View 0, and View 1 also depends on View 2.

The arrows in FIG. 6 show the dependency between view pictures captured at the same time. The arrows between pictures in the same view are omitted since the temporal dependency is considered total order within one view in the staggered MVC scheme 600.

Intra-view prediction may also be present in the examples of FIGS. 5 and 6, although there is no indication for that in the FIGS. 5 and 6, as intra-view prediction does not affect the decoding timing illustrated in the figures.

In FIGS. 5 and 6, for simplicity, the decoding time of every picture is depicted as deterministic and constant, which is usually not the actual case. Due to the different picture types (I, P, B and so forth), bit rates, coding modes and other factors, the decoding time of every picture (either in the same view or a different view) can be very different. Also, pictures in a view may selectively depend on pictures from other views, i.e., in the same view, some pictures may use intra-view prediction only, while other pictures use inter-view prediction only or both. The “jagged” decoding timing makes total parallelization of the decoding difficult or impossible. However, the parallelization can be improved by introducing a longer lag between the decoding thread/process, as a longer lag helps absorb the irregularity in the decoding timing.

In summary, a key point in the staggered MVC decoding is that every view is decoded in a separate decoding thread/process. The decoding timing is staggered so that the decoding of a picture only starts when its inter-view reference pictures are fully decoded (in other threads/processes).

In practice, the staggered timing usually does not need to be explicitly declared or configured, as the communication mechanism (semaphores and mutexes, for example) between the decoding threads/processes can automatically align the decoding threads/processes to the correct timing.

Further, in some video standards (such as the MPEG-4 AVC Standard and the MVC extension of the MPEG-4 AVC Standard), a picture can be divided into slices that can be decoded independent of each other. That means a picture can be decoded in parallel by multiple threads/processes, each of which decodes one slice. The parallelization at the slice level can be combined with that at the view level described before and further improves the decoding efficiency provided there are enough processing units.

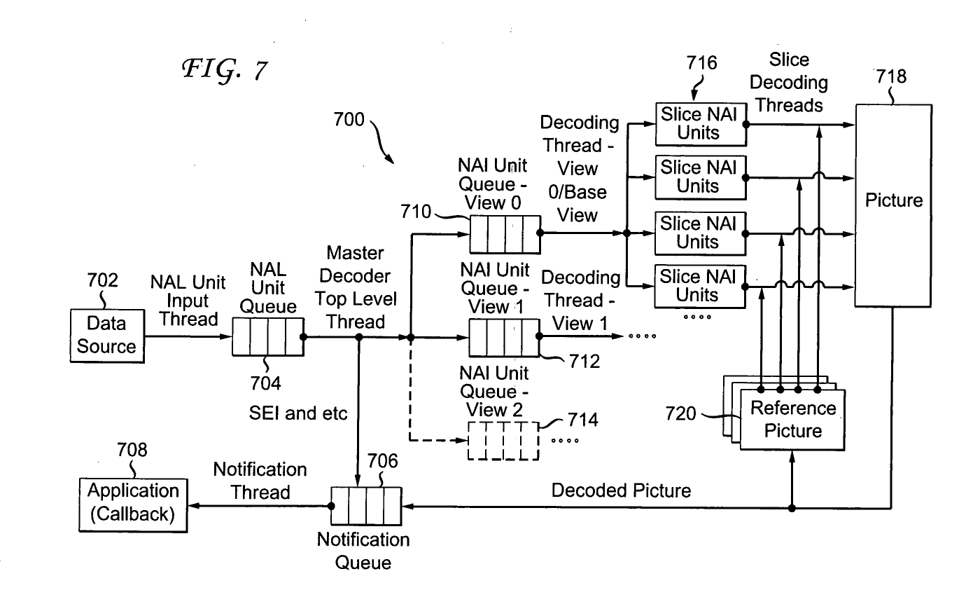

Turning to FIG. 7, an exemplary structure of the threads for decoding bitstreams encoded using the MVC extension of the MPEG-4 AVC Standard is indicated generally by the reference numeral 700. In the exemplary structure 700, the view level parallelization and the slice level parallelization are combined. A data source 702 has an output connected in signal communication with an input of a network abstraction layer (NAL) unit queue 704, for providing an NAL unit input thread. An output of the NAL unit queue 704 is connected in signal communication with respective inputs of NAL unit queues 710, 712, and 714, for providing a master decoder top level thread. The output of the NAL unit queue 704 is also connected in signal communication with a first input of a notification queue 706, for providing supplemental enhancement information (SEI) messages, and so forth. An output of the NAL unit queue 710, which corresponds to a decoding thread-view 0/base view, provides corresponding slice NAL units. An output of the NAL unit queue 712, which corresponds to a decoding thread-view 1, provides corresponding slice NAL units. An output of the NAL unit queue 714, although not shown, which corresponds to a decoding thread-view 2, provides corresponding slice NAL units. Of course, such structure may include additional elements such as additional NAL unit queues corresponding to additional views. The slice NAL units provided from the NAL unit queues 710, 712, and 714 are used, along with reference pictures 720, to decode a picture 718. The picture 718 may itself then be used a reference picture, and is also provided to a second input of the notification queue 706. An output of the notification queue 706 is connected to an input of an application (callback), for providing a notification thread.

Given the teachings of the present principles provided herein, one of ordinary skill in this and related arts will readily understand and be able to derive similar structure that can be applied to other video coding standards, recommendations, and extensions thereof, while maintaining the spirit of the present principles.

We note that the terminology “process/thread” as used herein is meant to be generic and not limited to pure software threads/processes. The decoding process can be carried out on either a general-purpose processor(s) and/or dedicated specialized hardware. For example, the base view data in an MPEG-4 AVC Standard bitstream is fully compatible with the regular MPEG-4 AVC Standard single view specification, and there are many (cheap) graphics card capable of decoding regular MPEG-4 AVC Standard single view bitstreams. It is conceivable that when decoding an MPEG-4 AVC Standard MVC bitstream on a general purpose computer, the base view data can be decoded by an add-on graphic card. Such a configuration would still be an example of the architecture described in accordance with the present principles.

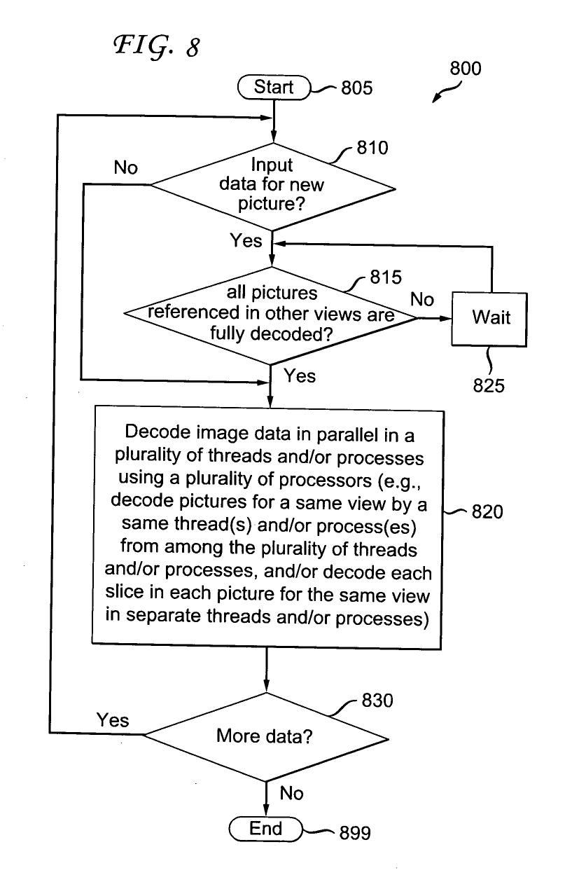

Turning to FIG. 8, an exemplary method for decoding multi-view coded video data is indicated generally by the reference numeral 800. The method 800 includes a start block 805 that passes control to a decision block 805. The decision block 805 determines whether or not input data for a new picture has been received. If so, then control is passed to a decision block 815. Otherwise, control is passed to a function block 820. The decision block 815 determines whether or not all pictures referenced in other views are fully decoded. If so, then control is passed to a function block 820. Otherwise, control is passed to a function block 825. The function block 820 decodes the input data in parallel in a plurality of threads and/or processes (which may be performed using a plurality of processors to expedite the procedure), and passes control to a decision block 830. The decision block 830 determines whether or not there is more data. If so, then control is passed to the decision block 810. Otherwise, control is passed to an end block 899. The function block 825 waits for a period of time, and passes control to a decision block 815.

A description will now be given of some of the many attendant advantages/features of the present invention, some of which have been mentioned above. For example, one advantage/feature is an apparatus having one or more decoders for decoding image data from a bitstream. The image data corresponds to a plurality of pictures for at least two views of multi-view video content. The image data is decoded in parallel in a plurality of at least one of threads and processes. The image data is decoded using a staggered approach such that a decoding of a particular one of the plurality of pictures in a particular one or more of the plurality of at least one of threads and process commences only when inter-view reference pictures corresponding to the particular one of the plurality of pictures are decoded using one or more other ones of the plurality of at least one of threads and processes.

Another advantage/feature is the apparatus having the one or more decoders as described above, wherein all of the plurality of pictures form a set, and only particular pictures of the plurality of pictures in the set without dependency are processed in parallel.

Yet another advantage/feature is the apparatus having the one or more decoders as described above, wherein any of the plurality of pictures for a same one of the at least two views are decoded by at least one of a same thread and a same process from among the plurality of at least one of threads and processes.

Still another advantage/feature is the apparatus having the one or more decoders as described above, wherein the bitstream is compliant with a multi-view video coding extension of the International Organization for Standardization/International Electrotechnical Commission Moving Picture Experts Group-4 Part 10 Advanced Video Coding Standard/International Telecommunication Union, Telecommunication Sector H.264 Recommendation.

Moreover, another advantage/feature is the apparatus having the one or more decoders as described above, wherein the image data for the plurality of pictures for each of the at least two views is respectively partitioned on a view-basis, and each slice in each of the plurality of pictures for a respective given one of the at least two views is decoded in separate ones of the plurality of at least one of threads and processes.

Further, another advantage/feature is the apparatus having the one or more decoders as described above, wherein each of the plurality of at least one of threads and processes correspond to a separate one of the one or more decoders.

Also, another advantage/feature is the apparatus having the one or more decoders as described above, wherein when decoding corresponding ones of the plurality of pictures for the at least two views, a time lag is introduced between decoding different ones of the at least two views to provide a resultant timing for decoding at least some of the corresponding ones of the plurality of pictures for the at least two views in parallel.

These and other features and advantages of the present principles may be readily ascertained by one of ordinary skill in the pertinent art based on the teachings herein. It is to be understood that the teachings of the present principles may be implemented in various forms of hardware, software, firmware, special purpose processor(s), or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. An apparatus, comprising:
one or more decoders for decoding image data from a bitstream, the image data corresponding to a plurality of pictures for at least two views of multi-view video content, wherein the image data is decoded in parallel in a plurality of at least one of threads and processes, the image data being decoded using a staggered approach such that a decoding of a particular one of the plurality of pictures in a particular one or more of the plurality of at least one of threads and processes commences only when inter-view reference pictures corresponding to the particular one of the plurality of pictures are decoded using one or more other ones of the plurality of at least one of threads and processes.

2. The apparatus of claim 1, wherein all of the plurality of pictures form a set, and only particular pictures of the plurality of pictures in the set without dependency are processed in parallel.

3. The apparatus of claim 1, wherein any of the plurality of pictures for a same one of the at least two views are decoded by at least one of a same thread and a same process from among the plurality of at least one of threads and processes.

4. The apparatus of claim 1, wherein the bitstream is compliant with a multi-view video coding extension of the International Organization for Standardization/International Electrotechnical Commission Moving Picture Experts Group-4 Part 10 Advanced Video Coding Standard/International Telecommunication Union, Telecommunication Sector H.264 Recommendation.

5. The apparatus of claim 1, wherein the image data for the plurality of pictures for each of the at least two views is respectively partitioned on a view-basis, and each slice in each of the plurality of pictures for a respective given one of the at least two views is decoded in separate ones of the plurality of at least one of threads and processes.

6. The apparatus of claim 1, wherein each of the plurality of at least one of threads and processes correspond to a separate one of the one or more decoders.

7. The apparatus of claim 1, wherein when decoding corresponding ones of the plurality of pictures for the at least two views, a time lag is introduced between decoding different ones of the at least two views to provide a resultant timing for decoding at least some of the corresponding ones of the plurality of pictures for the at least two views in parallel.

8. A method performed by one or more decoders, comprising:
decoding image data from a bitstream, the image data corresponding to a plurality of pictures for at least two views of multi-view video content, wherein the image data is decoded in parallel in a plurality of at least one of threads and processes, the image data being decoded using a staggered approach such that a decoding of a particular one of the plurality of pictures in a particular one or more of the plurality of at least one of threads and processes commences only when inter-view reference pictures corresponding to the particular one of the plurality of pictures are decoded using one or more other ones of the plurality of at least one of threads and processes.

9. The method of claim 8, wherein all of the plurality of pictures form a set, and only particular pictures of the plurality of pictures in the set without dependency are processed in parallel.

10. The method of claim 8, wherein any of the plurality of pictures for a same one of the at least two views are decoded by at least one of a same thread and a same process from among the plurality of at least one of threads and processes.

11. The method of claim 8, wherein the bitstream is compliant with a multi-view video coding extension of the International Organization for Standardization/International Electrotechnical Commission Moving Picture Experts Group-4 Part 10 Advanced Video Coding Standard/International Telecommunication Union, Telecommunication Sector H.264 Recommendation.

12. The method of claim 8, wherein the image data for the plurality of pictures for each of the at least two views is respectively partitioned on a view-basis, and each slice in each of the plurality of pictures for a respective given one of the at least two views is decoded in separate ones of the plurality of at least one of threads and processes.

13. The method of claim 8, wherein each of the plurality of at least one of threads and processes correspond to a separate one of the one or more decoders.

14. The method of claim 8, wherein when decoding corresponding ones of the plurality of pictures for the at least two views, a time lag is introduced between decoding different ones of the at least two views to provide a resultant timing for decoding at least some of the corresponding ones of the plurality of pictures for the at least two views in parallel.
